(19) United States
(12) Patent Application Publication
(10) Pub. No.: US 2025/0037259 A1
(43) Pub. Date: Jan. 30, 2025

(54) INFORMATION PROCESSING APPARATUS AND CONTROL METHOD THEREOF

(71) Applicant: CANON KABUSHIKI KAISHA, Tokyo (JP)

(72) Inventors: SHINICHI MITSUMOTO, Saitama (JP); SATORU MAMIYA, Kanagawa (JP)

(21) Appl. No.: 18/785,797

(22) Filed: Jul. 26, 2024

(30) Foreign Application Priority Data
Jul. 28, 2023 (JP) 2023-123758

(51) Int. Cl. G06T 7/00; G06T 7/33

(52) U.S. Cl. CPC G06T 7/0002; G06T 7/337; G06T 2207/30184

(57) ABSTRACT

An information processing apparatus obtains first defect data generated based on a first captured image of a target object at a first time point, obtains second defect data generated based on a second captured image of the target object at a second time point, corrects position coordinates of the second defect data using a first correction method in order to align a position in the first defect data with a position in the second defect data, and further corrects, using a second correction method, the position coordinates of the second defect data that have been corrected by the first correction method. The apparatus determines, based on comparison between the first defect data and the corrected second defect data, a common portion and a difference portion.

### BACKGROUND

### Field of the Disclosure

The present disclosure relates to a technique for deriving differences between a plurality of pieces of image data.

### Description of the Related Art

In recent years, image-based inspection has been widely conducted that involves determining the degree of integrity of a structure from a captured image of the structure. For example, defect (damaged) portions of the image are extracted using manual tracing or an image recognition technique, and the degree of integrity is determined based on the positions, the sizes, and the quantities of those portions. Japanese Patent Laid-Open No 2019-211277 discloses a technique for determining the aging of defects from images of the same structure that have been captured at different time points.

However, due to differences in, for example, image capturing conditions, positional displacement may occur between images obtained at different time points. In Japanese Patent Laid-Open No 2019-211277, the relationship between cracks respectively detected in two images is estimated. However, when the image capturing regions of the two image are significantly different, positional displacement makes it difficult to perform comparison. For example, there is a problem that the search range for feature point association may be significantly widened, thus increasing the computing cost, or making it difficult to achieve correct positional alignment due to increased erroneous associations.

### SUMMARY

According to one aspect of the present disclosure, an information processing apparatus comprises one or more memories storing instructions and one or more processors that are in communication with the one or more memories. When executing the instructions, the one or more processors cooperate with the one or more memories to obtain first defect data generated based on a first captured image obtained by capturing an image of a target object at a first time point, the first defect data indicating a defect in the target object; obtain second defect data generated based on a second captured image obtained by capturing an image of the target object at a second time point different from the first time point, the second defect data indicating a defect in the target object; correct position coordinates of the second defect data using a first correction method in order to align a position in the first defect data with a position in the second defect data; further correct, using a second correction method different from the first correction method, the position coordinates of the second defect data that have been corrected using the first correction method; and determine, based on comparison between the first defect data and the second defect data corrected using the second correction method, a common portion that is a defect portion common to the two pieces of defect data, and a difference portion that is a defect portion different between the two pieces of defect data.

Embodiments of the present disclosure enable a difference portion between a plurality of images to be more appropriately grasped.

Further features of various embodiments will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 is a diagram showing a hardware configuration of an information processing apparatus.

FIG. 2 is a diagram illustrating a relationship between a cross-sectional view of a tunnel and an inspection image.

FIGS. 3A and 3B are diagrams illustrating situations in which images of the inner wall of the tunnel are captured.

FIGS. 4A and 4B are diagrams showing examples of a management table.

FIGS. 5A and 5B are diagrams showing examples of a defect data table.

FIGS. 6A and 6B are diagrams showing examples of rendering of defect data.

FIG. 7 is a diagram showing an example of a GUI screen.

FIG. 8 is a diagram showing an example of a form of display of a state change.

FIG. 9 is a flowchart of state change determination processing.

FIG. 10 is a detailed flowchart of global positional displacement correction processing (S902).

FIGS. 11A and 11B are diagrams illustrating a method for calculating a global positional displacement amount.

FIGS. 12A and 12B are diagrams showing examples of a corrected inspection image and a defect data table.

FIG. 13 is a detailed flowchart of local positional displacement correction processing (S903).

FIGS. 14A and 14B are diagrams illustrating a method for calculating a local positional displacement amount.

FIG. 15 is a diagram showing an example of a defect data table after performing local positional displacement correction.

FIG. 16 is a detailed flowchart of aging determination processing (S904).

FIG. 17 is a detailed flowchart of aging data calculation processing (S1603).

FIGS. 18A to 18C are diagrams illustrating expansion processing.

FIGS. 19A and 19B are diagrams showing an example of a relationship between common portions and difference portions.

FIGS. 20A to 20C are diagrams showing examples of defect data tables of common portions and difference portions.

FIG. 21 is a diagram showing an example of a display screen of aging calculation results.

FIG. 22 is a diagram showing an example of a template used in global positional displacement calculation processing.

FIG. 23 is a diagram showing an example of a GUI screen according to a variation.

FIG. 24 is a diagram showing an example of a display screen of aging calculation results according to a variation.

### DESCRIPTION OF THE EMBODIMENTS

Hereinafter, embodiments will be described in detail with reference to the attached drawings. Note, the following embodiments are not intended to limit the scope of every embodiment. Multiple features are described in the embodiments, but limitation is not made to an embodiment that requires all such features, and multiple such features may be combined as appropriate. Furthermore, in the attached drawings, the same reference numerals are given to the same or similar configurations, and redundant description thereof is omitted.

### First Embodiment

A first embodiment of an information processing apparatus according to the present disclosure will be described below, taking, as an example, an information processing apparatus configured to detect aging (temporal change) of defects on a lining surface of a tunnel. More specifically, a description will be given of an exemplary information processing apparatus configured to determine state change such as development, degeneration, or disappearance due to a repair or the like of a defect; create defect data enabling the state change of the defect to be accurately reproduced; and display the state change of the defect so as to be grasped in various aspects.

Note that in the following description, a “defect” refers to a crack or the like caused on a concrete surface due to deterioration of a concrete structure (a freeway, a bridge, a tunnel, a dam, etc.). A “crack” refers to a linear damage (damage represented by a start point, an end point, a length, and a width) caused on a surface of the structure.

### Apparatus Configuration

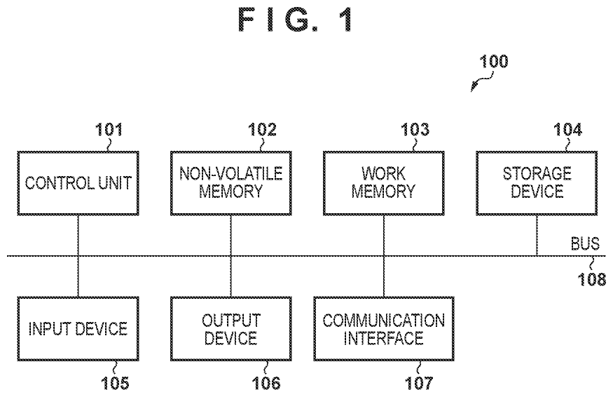

FIG. 1 is a block diagram showing a hardware configuration of an information processing apparatus 100. The information processing apparatus 100 may be realized by a single computer apparatus, or may be realized by a plurality of computer apparatuses.

The information processing apparatus 100 includes a control unit 101, a non-volatile memory 102, a work memory 103, a storage device 104, an input device 105, an output device 106, a network interface 107, and a system bus 108.

The control unit 101 includes an operation processor, such as a CPU or an MPU, that performs overall control of the information processing apparatus 100. The non-volatile memory 102 is a ROM that stores programs, parameters, and so forth that are executed by a processor of the control unit 101. Here, the program refers to a program for executing state change determination processing described below. The work memory 103 is a RAM that temporarily stores programs, data, and so forth that are supplied from an external apparatus or the like. The storage device 104 is an internal device, such as a hard disk or a memory card, that is contained in the information processing apparatus 100, or an external device, such as a hard disk or a memory card, that is removably connected to the information processing apparatus 100. The storage device 104 includes a memory card, a hard disk, or the like that is constituted by a semiconductor memory, a magnetic disk, or the like. In addition, the storage device 104 includes a storage medium constituted by a disk drive that reads/writes data from/to an optical disk such as a DVD, a Blu-ray (registered trademark), or the like.

The input device 105 is an operation member, such as a mouse, a keyboard, or a touch panel, that receives user operations and outputs operation instructions to the control unit 101. The output device 106 is a display apparatus, such as a monitor constituted by a liquid crystal display (LCD), an organic EL display, or the like, and displays data held by the information processing apparatus 100, and data supplied from an external device. The network interface 107 is communicably connected to a network, such as the Internet and a local area network (LAN). The system bus 108 includes an address bus, a data bus, and a control bus that connect the above-described constituent elements so as to enable data to be exchanged therebetween.

The non-volatile memory 102 records an operating system (OS), which is basic software executed by the control unit 101, and a program that implements applied functions in cooperation with the OS. In the present embodiment, the non-volatile memory 102 stores a program for the information processing apparatus 100 to implement state change determination processing described below.

The processing executed by the information processing apparatus 100 according to the present embodiment is implemented by reading software provided by the program. Note that the program includes a program for using a basic function of the OS installed in the information processing apparatus 100. Note that the OS of the information processing apparatus 100 may include a program for implementing the processing in the present embodiment.

### Inspection Image

The first embodiment assumes that an inspection target object is a lining surface of a tunnel. Accordingly, defect data described below is generated from inspection images obtained by capturing images of the lining surface of the tunnel. The following first describes a method for obtaining the inspection images, and a situation in which displacement between the images occurs at that time.

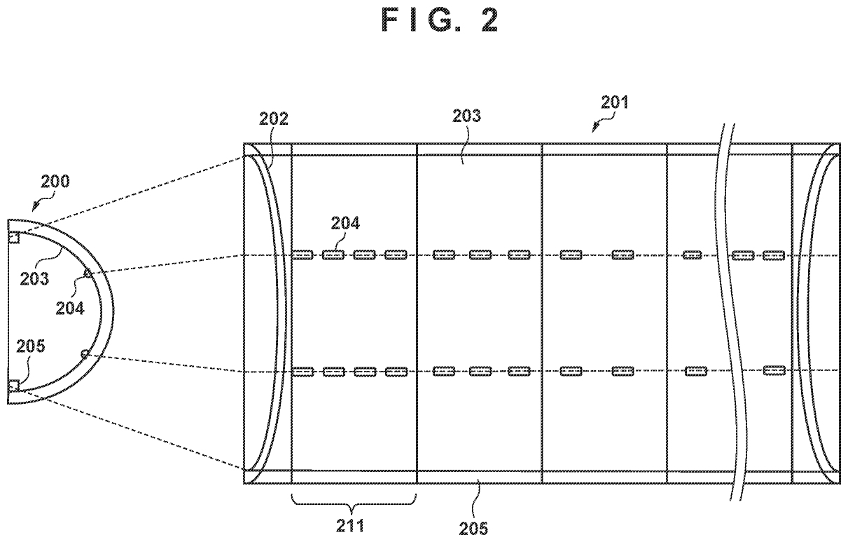

FIG. 2 is a diagram illustrating a relationship between a cross-sectional view of a tunnel and inspection images. FIG. 2 shows a development view 201 of a tunnel cross section 200 (the left side thereof corresponds to a road surface) and an inner wall of the tunnel. Left and right ends of the development view 201 are opening portions 202 serving as the tunnel entrance and exit, and a plurality of spans 211 are included between the opening portions 202 at the two ends. Note that spans are sections serving as units of casting concrete on the lining surface. Each of the spans 211 includes a lining surface 203, lighting 204, and a curb 205. Inspection is performed in units of spans that are repeated in the extension direction of the tunnel. Note that in the following description, the left-right direction (direction in which the plurality of spans are arranged) in the development view 201 may be referred to as a horizontal direction, and the up-down direction may be referred to as a vertical direction.

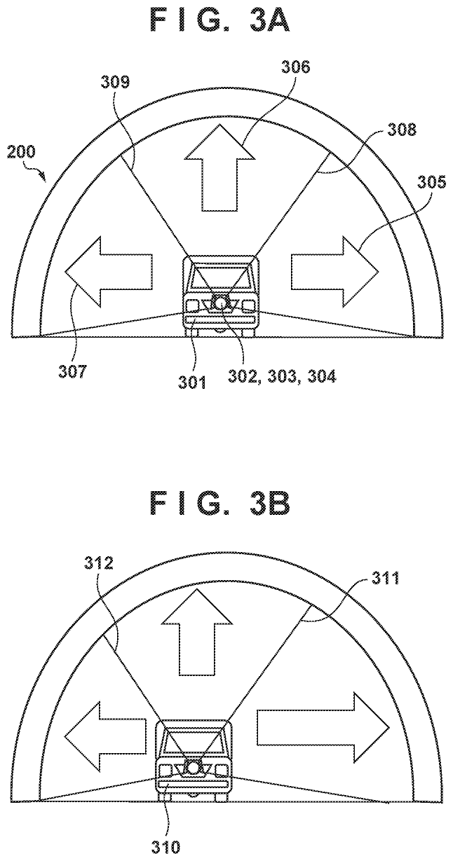

FIGS. 3A and 3B are diagrams illustrating a situation in which images of the tunnel inner wall are captured. Specifically, FIGS. 3A and 3B are diagrams (similar to the tunnel cross section 200) showing the interior of the tunnel as viewed from an opening portion 202 of the tunnel. To capture inspection images of the lining surface 203 (here, the spans 211) to be inspected, a vehicle 301 having three line sensor cameras attached thereto travels along a path inside the tunnel as shown in FIG. 3A. The three line sensor cameras 302 to 304 attached are oriented in directions different from each other, and boundaries 308 and 309 indicate boundaries between the image capturing ranges of the cameras.

FIG. 3B illustratively shows a situation when images of the same tunnel are captured at different time periods (time points), showing that the vehicle 310 includes the same number of (three) cameras, but travels at a position different from the position shown in FIG. 3A. Accordingly, in FIGS. 3A and 3B, although the three cameras capture images with the same angle of view, the boundary positions in the image capturing ranges are changed due to the distance to the wall surface of the tunnel. Specifically, the boundaries 308 and 309 are changed to boundaries 311 and 312, respectively. As a result, the respective image capturing ranges of the cameras are changed.

Each of the inspection images is generated by combining images captured by the three cameras. In the following description, an inspection image is assumed be an image in a range corresponding to a span, but may be configured so as to have a length in the horizontal direction that is different from the span. When the image capturing ranges of the cameras are changed, the amounts of size adjustment of images captured by the cameras are changed, thus causing positional displacement between the inspection images obtained in FIGS. 3A and 3B.

When a plurality of inspection target regions (spans) are successively formed in the horizontal direction as in the case of a tunnel, the lengths of inspection images in the horizontal direction are adjusted such that the connection surface (boundary) between adjacent inspection images coincide with each other. On the other hand, for the vertical direction, each inspection image may include a region wider than the inspection target region. This may occur due to using different methods for capturing or combining captured images, or due to capturing images by different operators. For example, when a region not to be inspected is included in an upper portion of each image in the vertical direction, the position of the target region is displaced, resulting in positional displacement between inspection images at two time points (FIGS. 3A and 3B). Accordingly, the positions of the defect data pieces generated from the inspection images are also displaced between the two time points.

### Defect Data

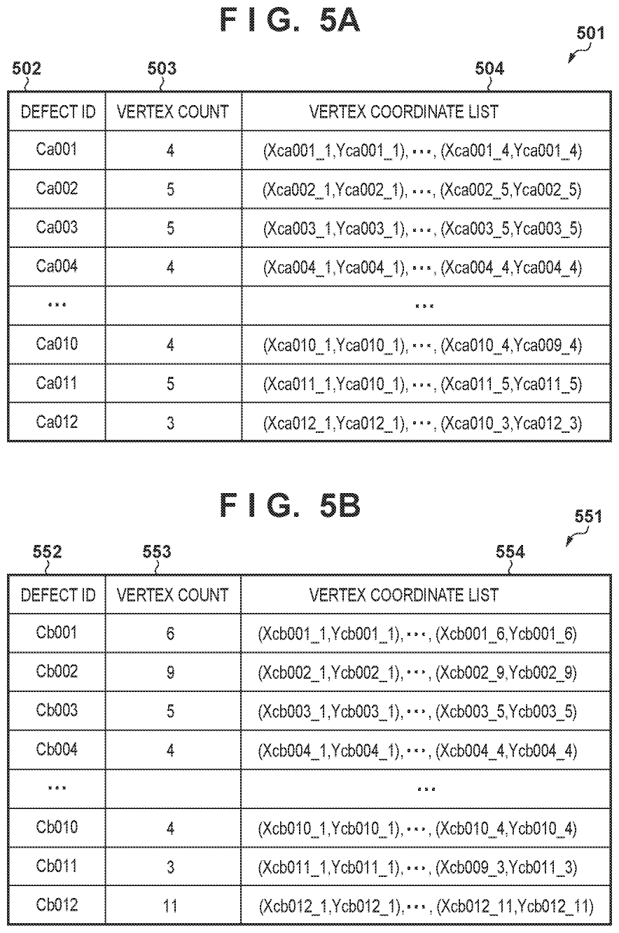

In the present embodiment, defect data in which a defect is represented as vector data is used. Here, a crack is described as an example of the defect. The defect data can be represented in the forms shown in FIGS. 5A and 5B. Each piece of the defect data is generated, for example, by a user tracing a defect included in a displayed inspection image. Also, the defect data can be automatically generated by image analysis processing or the like, or may be input by combining these methods. Image analysis processing may be executed using a learning model created by machine learning and deep learning of the artificial intelligence (AI).

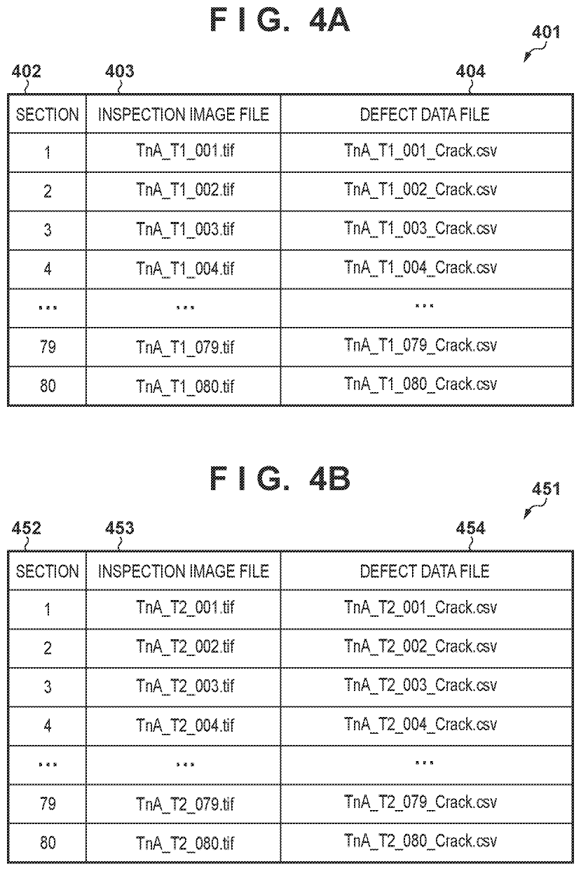

Next, a data structure of data to be inspected in the present embodiment will be described with reference to FIGS. 4A to 7.

FIGS. 4A and 4B are diagrams showing examples of a management table. The management table shown in FIG. 4A illustratively shows a first inspection data table 401 indicating a relationship between a section, an inspection image, and defect data at a first time point. The management table shown in FIG. 4B illustratively shows a second inspection data table 451 indicating a relationship between a section, an inspection image, and defect data at a second time point after the first time point. Here, a pair of an inspection image and defect data for each section is taken as one piece of inspection data (i.e., each inspection data includes an inspection image and defect data), and a set of a plurality of pieces of inspection data corresponding to all of the sections is referred to as an inspection data group.

The first inspection data table 401 includes a section 402 serving as information (section number) for identifying a section (span), an inspection image file 403 corresponding to the section, and a defect data file 404 corresponding to the inspection image. Similarly, the second inspection data table 451 includes a section 452, an inspection image file 453, and a defect data file 454. The inspection data tables are saved in the storage device 104 as inspection data files. The destination to save the inspection data files may be, for example, a folder in which the inspection images are stored (or any location associated with the inspection images).

Sections represent units of inspection inside the tunnel, and are numbered consecutively from the beginning (e.g., the upstream side) to the end of the tunnel. Each inspection image file is a file in which an image corresponding to a section is stored. Each defect data file is a file in which a defect data table describing defect data obtained from an inspection image of the same section.

FIGS. 5A and 5B are diagrams showing examples of the defect data table. FIG. 5A illustratively shows a first defect data table 501 describing defect data obtained from a first inspection image captured at a first time point for a given section. FIG. 5B illustratively shows a second defect data table 551 describing defect data obtained from a second inspection image captured at a second time point for the same section as that in FIG. 5A.

In the first defect data table 501 and the second defect data table 551, one crack, which is defect data, is represented by a continuous polyline. The first defect data table 501 includes a defect ID 502 for identifying a defect, a vertex count 503, and a vertex coordinate list 504. Similarly, the second defect data table 551 includes a defect ID 552, a vertex count 553, and a vertex coordinate list 554.

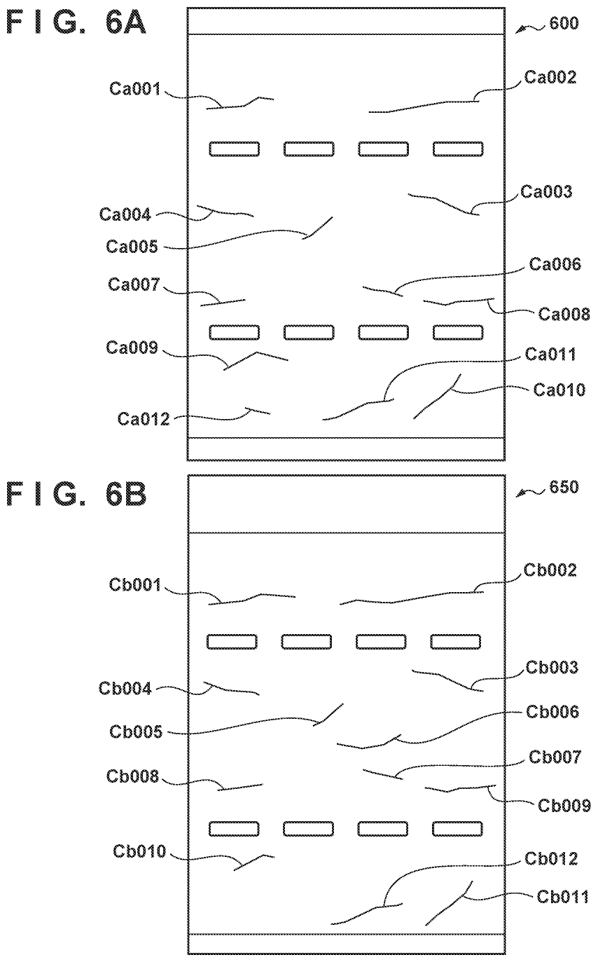

FIGS. 6A and 6B are diagrams showing examples of rendering of the defect data. FIG. 6A illustratively shows a superimposed image 600 in which the defect data pieces registered in the first defect data table 501 are displayed in a superposed manner for the first inspection image. In the superimposed image 600, Ca002 to Ca012 are cracks respectively corresponding to defect IDs Ca002 to Ca012 of the first defect data table 501.

Similarly, FIG. 6B illustratively shows a superimposed image 650 in which the defect data pieces registered in the second defect data table 551 are displayed in a superposed manner for the second inspection image. In the superimposed image 650, Cb002 to Cb010 are cracks respectively corresponding to defect IDs Cb002 to Cb010 of the second defect data table 551.

### State Change Data

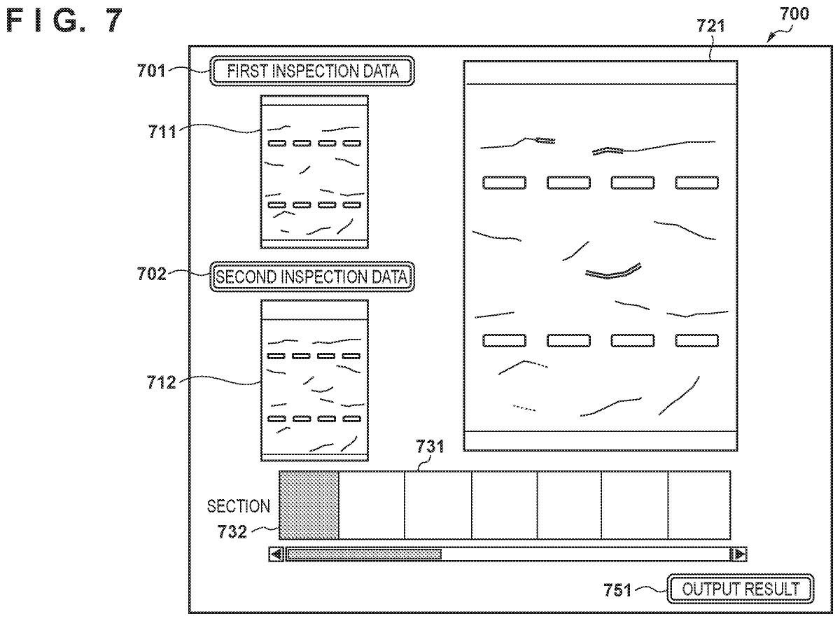

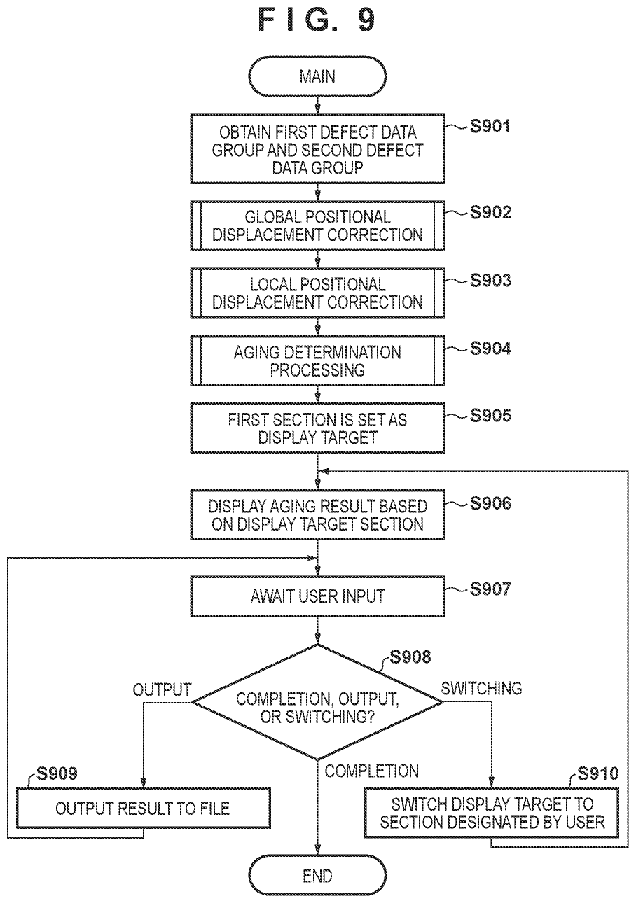

FIG. 7 is a diagram showing an example of a graphical user interface (GUI) screen 700 displayed by a program implementing state change determination processing executed in the information processing apparatus 100. The state change determination processing will be described later with reference to FIG. 9.

In the GUI screen 700, a first data input button 701 is a button for selecting a first inspection data group registered in the first inspection data table 401 shown in FIG. 4A. When the user operates the button 701, a file selection dialog (not shown) is displayed. When the user selects an inspection data file stored in the storage device 104, information of the inspection image files and the defect data files of all the sections described in the selected inspection data file is obtained.

Similarly, a second data input button 702 is a button for selecting a second inspection data group registered in the second inspection data table 451 shown in FIG. 4B. When the user operates the button 702, a file selection dialog (not shown) is displayed. When the user selects an inspection data file stored in the storage device 104, information of the image files and the defect data files of all the sections described in the selected inspection data file is obtained.

A first defect data display region 711 displays a superimposed image of the inspection data of a section selected as a display target, from among the inspection data group designated using the first data input button 701. The selection of a section as a display target is made through an operation performed on a section display region 731 described below. However, immediately after designating the inspection data, the first section is selected as the initial value. Note that a blank image is displayed before the inspection data is designated using the first data input button 701.

Similarly, a second defect data display region 712 is a region that displays a superimposed image of the inspection data designated using the second data input button 702. Similarly, immediately before designating the inspection data (before a section is selected), the first section is displayed. A blank image is displayed before the inspection data is designated using the second data input button 702.

A section display region 731 is a region that displays the entire sections of the tunnel, and the number of rectangles corresponding to the number of sections (here, the number of spans) that have been input are displayed at a stage when an inspection data group is input using either the button 701 or 702. The shape of a region indicating each section may be any shape that enables identification of the section, and may be a square, or a rectangle conforming to the aspect ratio of the inspection image. When no inspection data group is input, the section display region 731 is blank. A section display target region 732 indicates the section to be displayed in the first display region 711, the second display region 712, and a result display region 721, and is selected by the user. The section selection is made through a mouse operation (e.g., clicking) performed by the user. When the user selects one of the section regions within the section display region 731, the selected section region is highlighted as a section display target region.

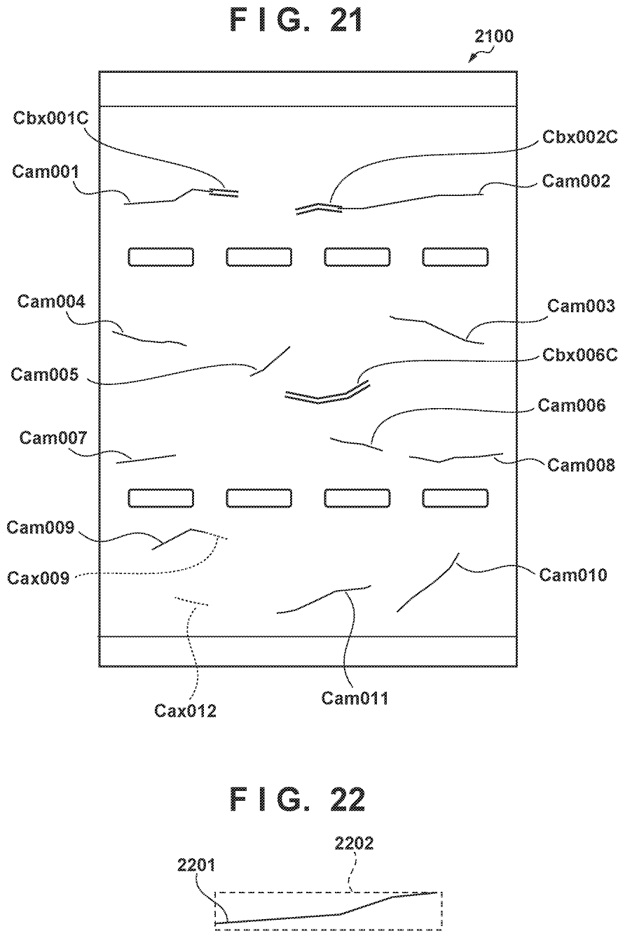

The result display region 721 is a region that displays state change data, which is a result of state change determination processing described below with reference to FIG. 9, for the first inspection data table 401 and the second inspection data table 451. For example, when the first inspection data and the second inspection data are input, state change determination processing is executed, and an image as shown in FIG. 21 described below is displayed in the result display region 721. Before and during execution of the state change determination processing, a blank image is displayed. At a stage when the user has not performed an operation to select the section display target region, a result of the state change determination processing corresponding to the first section is displayed. The state change data is data representing a result of calculating common portions and difference portions of defect data (e.g., the first inspection data table 401 and the second inspection data table 451) at two different time points.

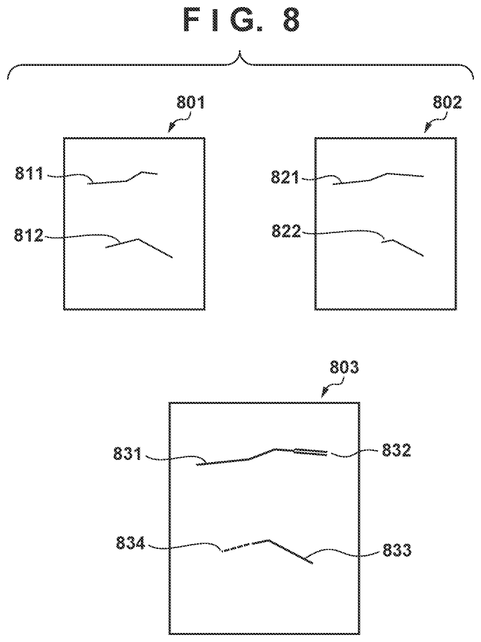

FIG. 8 is a diagram showing examples of a form of display of state change. Specifically, the drawing shows a relationship between two pieces of input inspection data and state change data, which is a result of change calculation.

First inspection data 801 at the first time point includes defect data 811 and defect data 812, and second inspection data 802 at the second time point includes defect data 821 and defect data 822. State change data 803 is an example of a result of calculating the state change between the first and second defect data, and is displayed in the result display region 721. The calculation result is displayed using to the first or second defect data as a reference. Here, the calculation result is displayed using the first defect data as a reference. Also, the second time point (second inspection data) is subsequent in time to the first time point (first inspection data).

In the state change data 803, solid lines 831 and 833 are defects determined to be common portions to the first defect data (reference) and the second defect data. On the other hand, a dotted line 834 and a double line 832 are defects determined to be difference portions between the first defect data (reference) and the second defect data. Specifically, the dotted line 834 is a defect portion that is present in the first defect data (reference) and absent in the second defect data (i.e., a “disappeared” defect portion). The double line 832 is a defect portion that is absent in the first defect data (reference) and present in the second defect data (i.e., a newly “appeared” defect portion). In this manner, the common portions and the difference portions are displayed so as to be distinguishable from each other. In addition, the “disappeared” defect portion and the “appeared” defect portion are displayed so as to be distinguishable from each other. Such display allows the user to easily grasp that the defect indicated by the double line 832 is caused by extension of the defect (crack) indicated by the solid line 831.

A result output button 751 is a button for outputting a result of the state change determination processing as a file. The data and file that are output as a result of the state change determination processing will be described later.

### Operations of Apparatus

FIG. 9 is a flowchart of state change determination processing. The state change determination processing is processing for determining aging using inspection data groups at two different time points as inputs, and displaying the result (e.g., FIG. 21 described below). To determine aging, positional displacement between the two inspection data groups is detected, and the positional displacement is corrected. The state change determination processing is implemented by the control unit 101 of the information processing apparatus 100 shown in FIG. 1 loading a program stored in the non-volatile memory 102 into the work memory 103 and executing the program to control the constituent elements.

In S901, the control unit 101 reads out the first inspection data group selected by the user using the button 701, and the second inspection data group selected by the user using the button 702. In the present embodiment, the first inspection data is handled as a reference for aging processing and display. That is, correction to align the position of the first inspection data with the position of the second inspection data is performed.

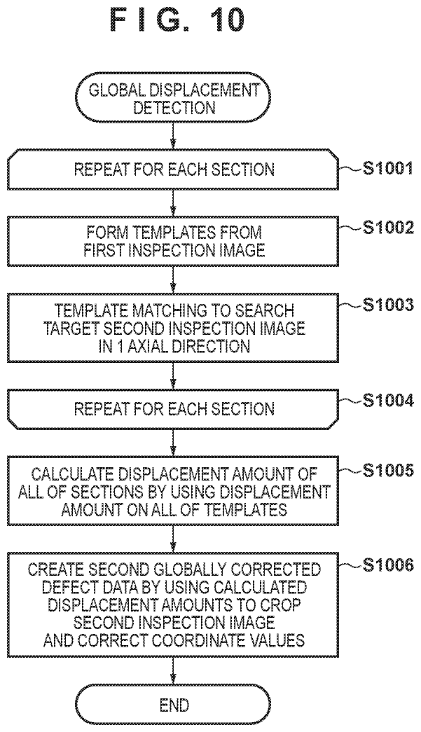

In S902, the control unit 101 performs correction (first correction method) of global positional displacement between the first inspection data and the second inspection data for the first inspection data group and the second inspection data group. That is, the position within the defect data included in the first inspection data and the position within the defect data included in the second inspection data are aligned with each other. Here, the position coordinates of the defect data included in the second inspection data are corrected. Global positional displacement refers to, for example, large positional displacement over the entire inspection target regions (spans). The details of the processing will be described later with reference to FIGS. 10 to 12B.

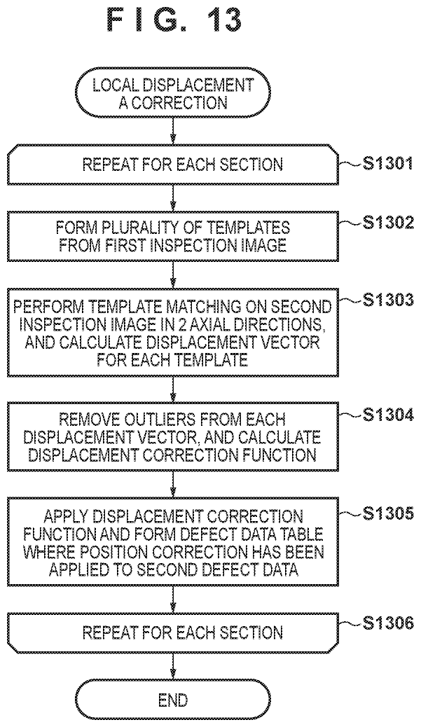

In S903, the control unit 101 performs correction (second correction method) of local positional displacement between the first inspection data group and the second inspection data group corrected by the processing in S902 for the inspection data of the two inspection data groups. Local positional displacement refers to small positional displacement, for example, within a partial region of an inspection target region (span). The details of the processing will be described later with reference to FIGS. 13 to 16.

In S904, the control unit 101 executes processing for determining aging between two different time points, using the first inspection data and the second inspection data for which positional correction has been performed by the processing in S903. The details of the processing will be described later with reference to FIGS. 16 to 21.

In S905, the control unit 101 sets a display target section to be displayed in the display regions 711, 712, and 721 of the GUI screen 700 serving as the display unit. For example, the first section is set as the display target section. In S906, the control unit 101 performs, based on the set display target section, display control to provide displays corresponding to the display regions 711, 712, and 721.

In S907, the control unit 101 receives an operation from the user using the input device 105. When an operation described below in relation to S908 is performed, the processing proceeds to S908. In S908, the control unit 101 determines which one of “completion (of state change determination processing)”, “output (to a processing result file)” and “switching (of the display target section)” corresponds to the user operation received using the input device 105.

For example, when an operation to close the window of the GUI screen 700 is performed, the processing ends. When the result output button 751 is depressed, the processing proceeds to S909. When an operation is performed on the section display region 731 to switch the display target section, the processing proceeds to S910.

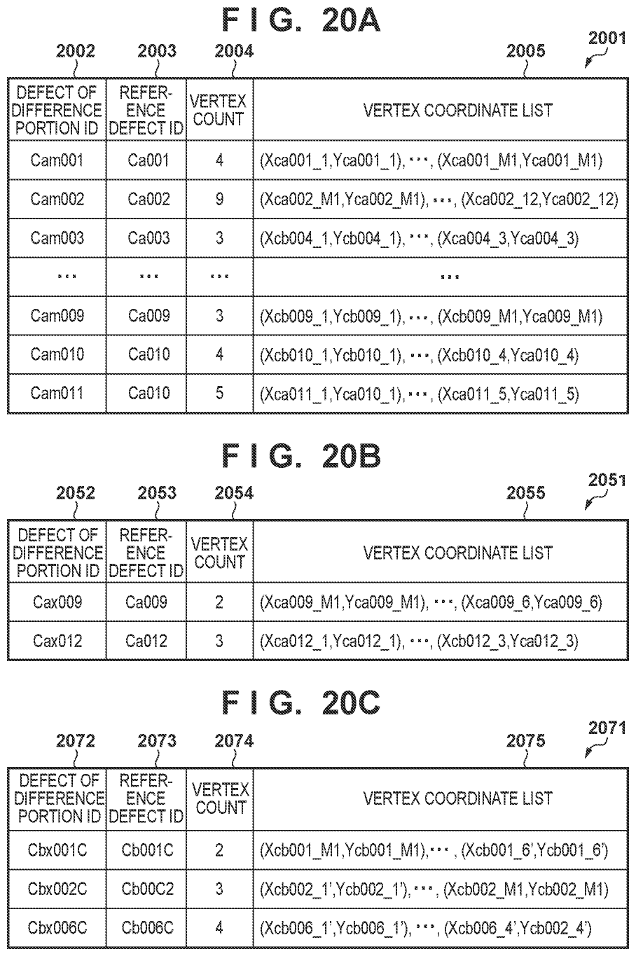

In S909, the control unit 101 outputs a defect data table, which is a result of the aging processing, as a file. That is, the defect data table is defect change data indicating aging of a defect. The content of the calculation result data that is output will be described later with reference to FIGS. 20A to 20C. After the output, the processing returns to S907. In S910, the control unit 101 sets the section designated by the user in the section display region 731 as a display target section, and the processing returns to S906.

### Global Positional Displacement Correction Processing

FIG. 10 is a detailed flowchart of the global positional displacement correction processing (S902). In S1001 to S1004, the control unit 101 repeats the processing on the first inspection data group and the second inspection data group stored in the storage device 104 in the order of the section numbers described in the inspection data table.

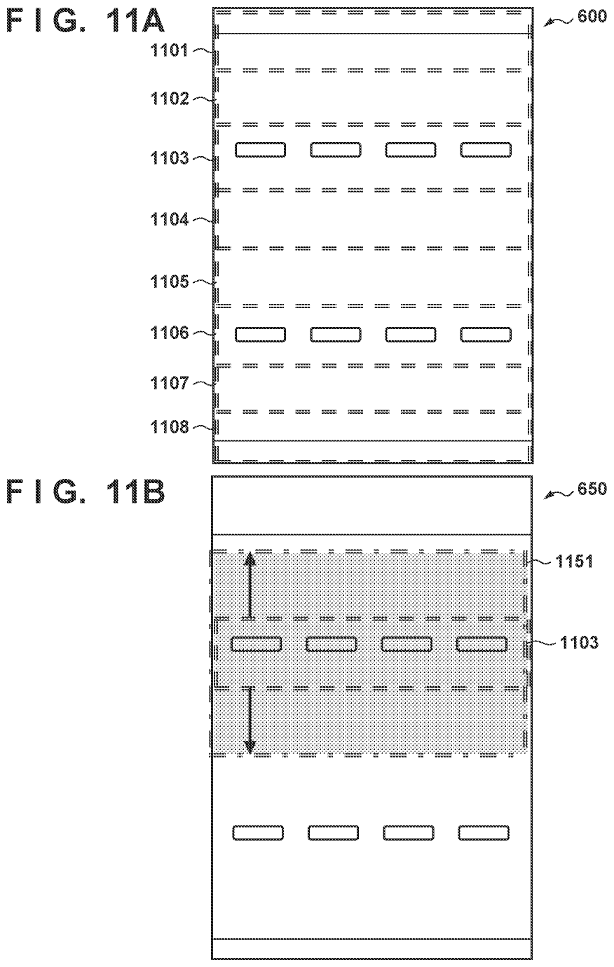

In S1002, the control unit 101 generates template images for the first inspection image. FIGS. 11A and 11B are diagrams illustrating a method for calculating a global positional displacement amount. For example, in a first inspection image 600 shown in FIG. 11A, strip-shaped rectangular regions extending in the horizontal direction, which are enclosed by the dotted lines, are generated as template images. In the example shown in FIG. 11A, eight template images 1101 to 1108 are generated.

In S1003, the control unit 101 performs template matching on the second inspection image with a search range (search direction) set in the vertical direction only (i.e., one-dimensional positional displacement detection), and calculates a displacement amount for each template. In the example shown in FIG. 11B, matching using the template image 1103 is performed within a search range 1151. For example, with the upper left origin coordinates of the first inspection image and the second inspection image aligned, the position in the Y direction (vertical direction) at which matching degree is the highest is determined using a score calculation method commonly used in the existing template matching. The displacement amount is a relative value, and corresponds to a difference in coordinates of a correction target (here, the second inspection image) from a correction reference (here, the first inspection image). Here, one-dimensional correction in the Y direction is performed. Accordingly, for example, when the Y coordinate of the upper side of the template 1103 is “200”, and the coordinate of the second inspection image on which the matching degree is the highest is “700”, the displacement amount is “+500”.

In S1004, the control unit 101 repeats the processing from S1002 to S1003 until the processing is completed for all of the sections (or one or more sections designated in advance by the user).

In S1005, the control unit 101 calculates the displacement amount for each section from the displacement amount determined using template matching in S1003. The displacement amount for each section is an average value obtained by removing outliers for the displacement amounts calculated from all of the templates in that section. For example, an average value of the displacement amounts of all of the templates is determined, and any values having a difference from the average value that is greater than a predetermined value are removed as outliers. Then, an average value thereof is determined again as the displacement amount of that section. For example, a value of twice the standard deviation of the displacement amount is used as the predetermined value.

In S1006, the control unit 101 corrects the inspection images and the defect data tables for all of the sections, based on the displacement amount calculated in S1005. To align the upper left origins of the images when executing local correction processing at a subsequent stage, the images are corrected according to the displacement amounts.

When the displacement amount of an image in the vertical direction (Y direction) has a positive value (displacement in the upper direction of the image exists), the upper region of the image is removed by an amount corresponding to the displacement amount. In addition, the value of the displacement amount is subtracted from the Y-coordinate value of the coordinate list in the defect data table. Conversely, when the displacement amount in the vertical direction (Y direction) of an image has a negative value, a region (with a pixel value indicating blank, for example) corresponding to the displacement amount is added to the upper portion of the image. In addition, the value of the displacement amount is added to the coordinate value of the coordinate list in the defect data table.

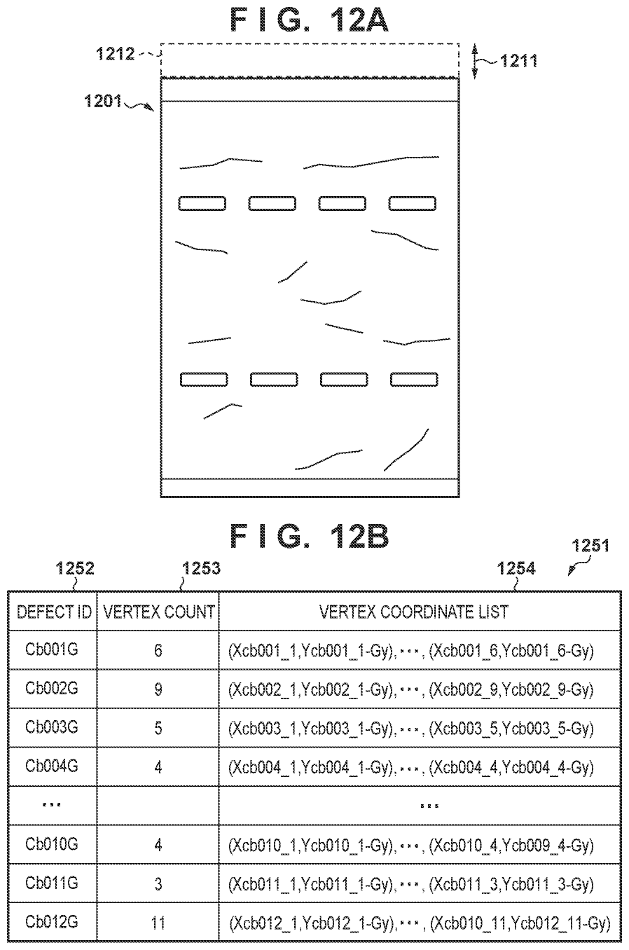

FIGS. 12A and 12B are diagrams showing examples of a corrected inspection image and a defect data table. Here, examples in which the displacement amount has a positive value are shown. A corrected image 1201 shown in FIG. 12A is an example in which the second inspection image 650 has been corrected. Using a displacement amount 1211 in the vertical direction calculated in S1005, the region indicated by a rectangle 1212 is removed such that the Y-coordinate value of the origin of the corrected image is equal to the displacement amount 1211.

A defect data table 1251 shown in FIG. 12B is a data table in which the displacement amount is applied to the second defect data table 551. As the letter for identifying that global positional correction has been applied, a letter G is appended to a defect ID 1252. The Y coordinates of a vertex coordinate list 1254 are Y coordinates obtained by subtracting the displacement amount Gy calculated in S1005 from the corresponding Y coordinates of the vertex coordinate list 554.

### Local Positional Displacement Correction Processing

FIG. 13 is a detailed flowchart of the local positional displacement correction processing (S903). In S1301 to S1306, the control unit 101 repeats the processing on the first inspection data group and the second inspection data group stored in the storage device 104 in the order of the section numbers described in the inspection data table.

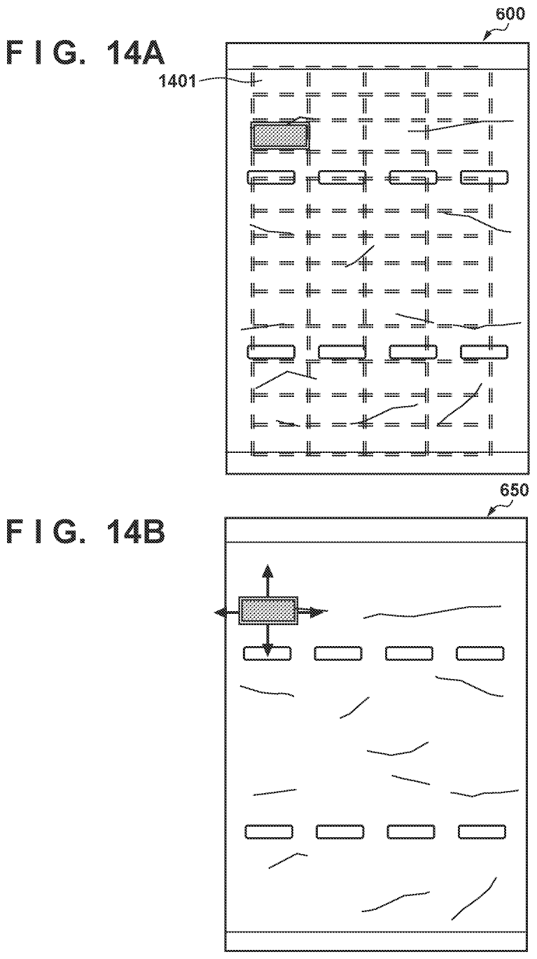

In S1302, the control unit 101 creates a plurality of template images from the first inspection image. To calculate local positional displacement, the plurality of template images have a small size (e.g., about a typical defect size). FIGS. 14A and 14B are diagrams illustrating a method for calculating a local positional displacement amount. For example, as template images, templates 1401 for the first inspection image 600 are created as shown in FIG. 14A. The templates 1401 have a smaller size than the templates 1101 shown in FIG. 11A.

In S1303, using the templates created in S1302, the control unit 101 performs template matching on the second inspection image (corrected image 1201) for which displacement has been corrected in S1007, as a correction target, and calculates the displacement amount from each of the templates. The template matching processing in S1303 may be executed using known template matching as in the case of S1003. In S1303, unlike S1003, the search range (search direction) is set in two directions, namely, the vertical direction and the horizontal direction (i.e., two-dimensional positional displacement detection). Since the global positional displacement correction processing (S902) has been already executed, it can be expected that a less amount of movement is required for template searching. Since the search range is handled biaxially, namely, horizontally and vertically, the displacement amount for local correction will be hereinafter handled as a two-dimensional displacement vector.

In S1304, using the displacement vector calculated in S1303 for each of the templates, the control unit 101 calculates a displacement estimate vector of each of the vertex coordinate values of the defect data. At that time, any displacement vectors corresponding to outliers are excluded, and the displacement estimate vector is calculated from a group of the excluded displacement vectors. As showing in the following equation (1), an x coordinate vₓ and a Y coordinate v_{y} of a displacement estimate vector v can be represented by estimation functions fₓ and f_{y} with respect to input vertex coordinates (x, y).

$${v}_{x} = {f}_{x} ( x , y ) \qquad ( 1 )$$

$${v}_{y} = {f}_{y} ( x , y )$$

A known method may be used to obtain the estimation functions fₓ and f_{y}, and the estimation functions fₓ and f_{y} can be calculated with multiple regression analysis, using x and y of the displacement vector as independent variables. Using the calculated fₓ and f_{y}, a corrected vector is calculated as shown in the following equation (2). That is, two-dimensional correction is performed here. Accordingly, displacement estimate vectors vₓ and v_{y} are subtracted from each of the coordinate values (X, Y) of the defect data, to calculate (X′, Y′).

$$[ \begin{matrix}{X}^{′} \\ {Y}^{′}\end{matrix} ] = [ \begin{matrix}X \\ Y\end{matrix} ] - [ \begin{matrix}{f}_{x} ( X , Y ) \\ {f}_{y} ( X , Y )\end{matrix} ] \qquad ( 2 )$$

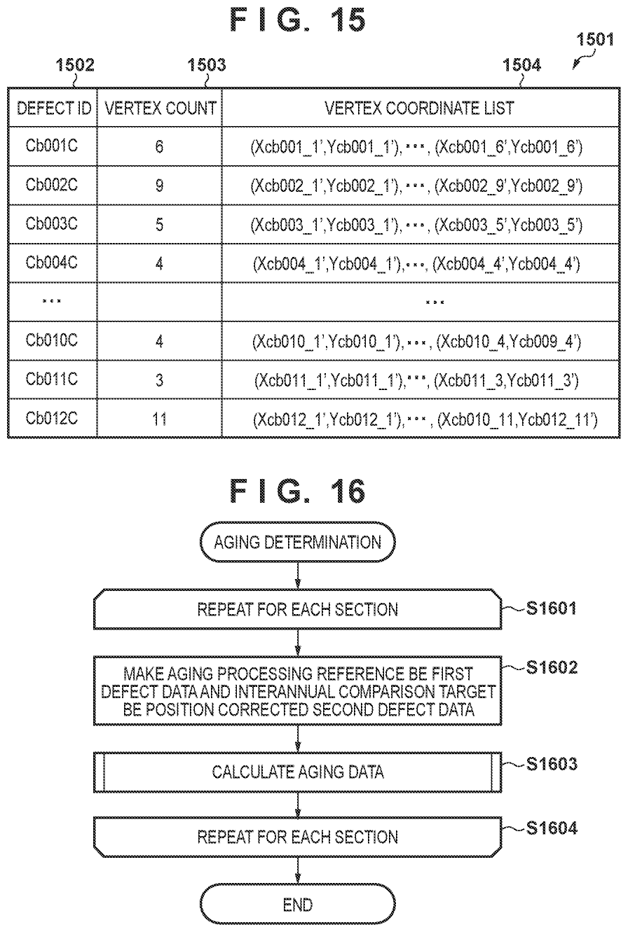

In S1305, the control unit 101 applies the estimation functions calculated in S1304 to the second defect data table for which the global positional displacement correction processing (S902) has been executed, and creates a second defect data table (FIG. 15) for which local positional displacement has been corrected. The created table is stored in the storage device 104.

In S1306, the processing from S1302 to S1305 is repeated until the processing is completed for all of the sections.

FIG. 15 is a diagram showing an example of a defect data table for which local positional displacement has been corrected. Here, as the letter for identifying that local positional correction has been applied, a letter C is appended to a defect ID 1502. The corrected coordinate values are described in a coordinate list 1504 in the defect data table.

### Aging Determination Processing

FIG. 16 is a detailed flowchart of the aging determination processing (S904). In S1601 to S1604, the control unit 101 repeats the processing in the order of the section numbers described in the inspection data tables stored in the storage device 104.

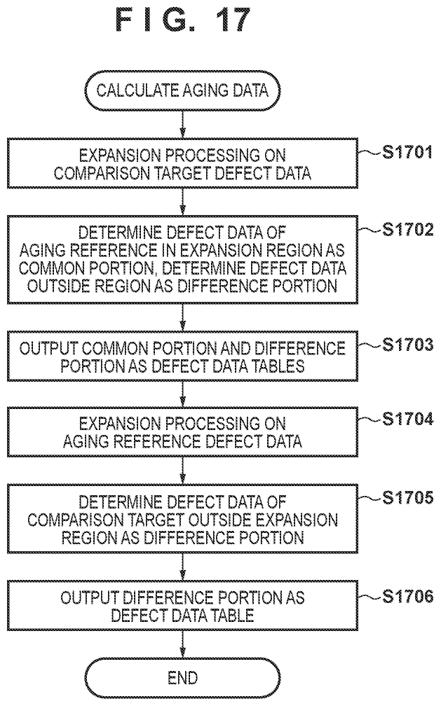

In S1602, the control unit 101 designates the first defect data as a reference for aging processing. In addition, the control unit 101 designates, as a comparison target, the second defect data for which positional correction has been performed. In S1603, the control unit 101 executes aging data calculation processing using the defect data designated in S1602. The details of the processing will be described later with reference to FIG. 17.

In S1604, the processing from S1602 to S1603 is repeated until the processing is completed for all of the sections.

FIG. 17 is a detailed flowchart of the aging data calculation processing (S1603).

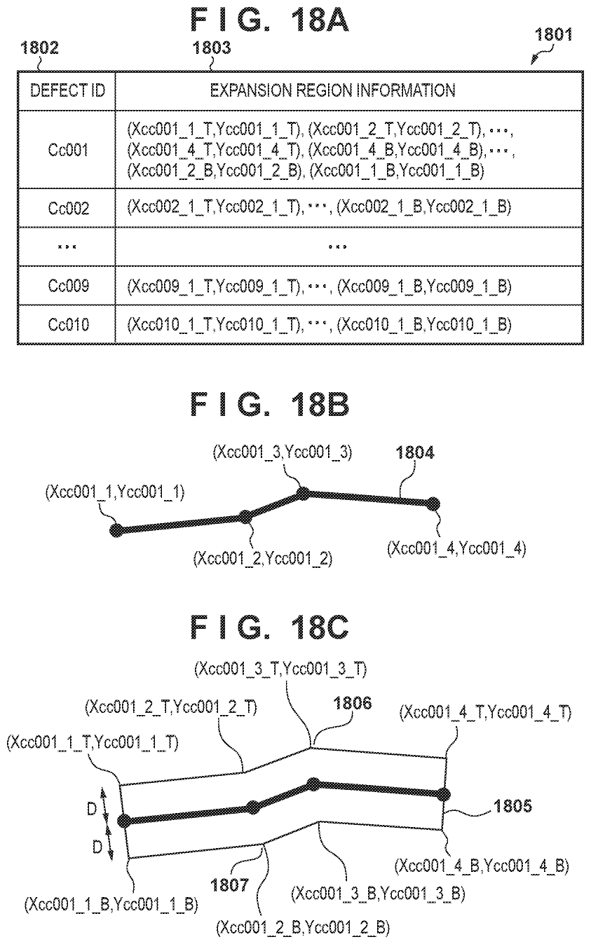

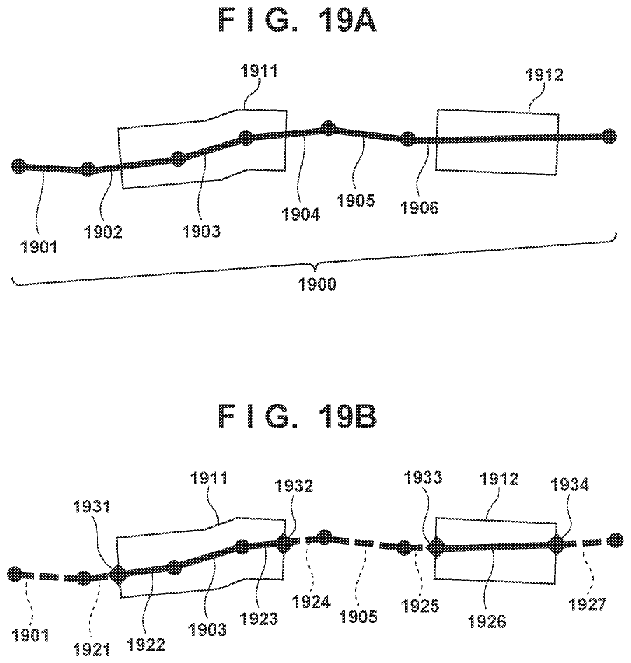

In S1701, the control unit 101 executes expansion processing on the defect data serving as a comparison target. The details of the expansion processing will be described later with reference to FIGS. 18A to 18C. In S1702, the control unit 101 determines defect data serving as a processing target present within an expansion region of the defect data serving as a comparison target to be a common portion. In addition, the control unit 101 determines defect data outside the expansion region to be a difference portion. The determination processing will be described later with reference to FIGS. 19A and 19B.

In S1703, the control unit 101 stores, in the storage device 104, the defect data of the common portion and the defect data of the difference portion that have been calculated in S1702 as defect data tables. The defect data tables of the common portion and the difference portion will be described later with reference to FIGS. 20A to 20C.

In S1704, the control unit 101 executes expansion processing on the defect data serving as a reference. The expansion processing is similar to that executed in S1701, but is different therefrom in that the defect data to be subjected to expansion processing in S1701 is the defect data serving as a reference. In S1705, the control unit 101 determines, of the defect data that has been subjected to the expansion processing, the defect data serving as a comparison target outside the expansion region to be a difference portion.

In S1706, the control unit 101 stores, in the storage device 104, the difference portion calculated in S1705 as a defect data table.

FIGS. 18A to 18C are diagrams illustrating the expansion processing (S1701 and S1704). FIG. 18A illustratively shows an expansion region data table 1801 created by executing the expansion processing on the defect data for each defect ID in the defect data table designated as the defect data to be subjected to the expansion processing.

The expansion region data table 1801 includes a defect ID 1802 and expansion region information 1803. The expansion region information 1803 is vector data representing a contour of an expansion region created as a result of executing the expansion processing on the defect data, and corresponds to, for example, a polygonal vertex coordinate list shown in FIG. 18C.

FIG. 18B illustratively shows a polyline 1804 of a crack that is rendered based on the defect data of a defect ID Cc001 before executing the expansion processing. A thin line 1805 shown in FIG. 18C illustratively shows a polygonal expansion region created by executing the expansion processing on the polyline 1804 shown in FIG. 18B. Note that black circles on the polyline 1804 correspond to the vertex coordinates registered in the vertex coordinate list of the defect ID Cc001.

The expansion region 1805 is a polygonal region obtained by translating the line segments constituting the polyline 1804 to both sides (in a direction substantially orthogonal to the polyline 1804) of the polyline 1804 by a predetermined distance D. Note that the shape of the expansion region 1805 is not limited to a polygonal shape, as long as the expansion region 1805 is a closed region. For example, in FIG. 18C, peripheral regions of vertexes 1806 and 1807 of bent portions may have a smooth profile. For example, these peripheral regions may each be replaced by a circular arc having a radius equal to the distance D around the corresponding bent portion of the polyline 1804. In particular, when the bent portions of the polyline 1804 are acute-angled, the distance to the line segments constituting the expansion region is significantly larger than the predetermined distance D. Accordingly, processing for rounding the corners of the expansion region eliminates missing regions in the expansion region, and thus is advantageous in determination processing of common portions and difference portions, which will be described later.

FIGS. 19A and 19B are diagrams showing an example of a relationship between common portions and difference portions. Specifically, the drawings illustratively show a relationship between defect data serving as a reference, and expansion region data created from the defect data that has been subjected to the expansion processing.

In FIG. 19A, a polyline 1900 indicates line segments connecting the vertex coordinates of the defect data serving as a reference. Line segments 1901 to 1906 indicate line segments connecting two adjacent vertexes of the polyline 1900. Expansion regions 1911 and 1912 indicate expansion region data created by the expansion processing in S1701. FIG. 19B illustratively shows display of defect data when portions within the expansion regions are determined to be common portions, and portions outside the expansion regions are determined to be difference portions.

Whether the line segments of the defect data 1900 overlap the expansion region 1911 and the expansion region 1912 is determined using a collision detection technique widely known in the fields of computer gaming and the like. The defect data 1900 is determined to have two common portions and three difference portions, and intermediate points 1931 to 1934 are generate at boundaries between the inside and the outside of the expansion regions on the line of the defect data 1900.

The line segment 1902 is divided into a line segment 1921 and a line segment 1922 by the intermediate point 1931. The line segment 1904 is divided into a line segment 1923 and a line segment 1924 by the intermediate point 1932. The line segment 1906 is divided into a line segment 1925, a line segment 1926, and a line segment 1927 by the intermediate points 1933 and 1934.

The common portions included within the expansion region 1911 are constituted by the line segment 1922, the line segment 1903, and the line segment 1923. The common portion included within the expansion region 1912 is constituted by the line segment 1926. The first difference portion outside the expansion regions is constituted by the line segment 1901 and the line segment 1921. The second difference portion is constituted by the line segment 1924, the line segment 1905, and the line segment 1925. The third difference portion is constituted by the line segment 1927.

FIGS. 20A to 20C are diagram showing examples of defect data tables of common portions and difference portions. FIG. 20A illustratively shows a defect data table 2001 of common portions (defects present in both the first and second defect data) that are output in S1703. FIG. 20B illustratively shows a defect data table 2051 of difference portions (defects present only in the first defect data) that are output in S1703. FIG. 20C illustratively shows a defect data table 2071 of difference portions (defects present only in the corrected second defect data) that are output in S1706.

The defect data table 2001 includes a defect ID 2002 for identifying defect data of a common portion, a reference defect ID 2003 for identifying defect data serving as a reference before being differentiated to be a common portion or a difference portion, a vertex count 2004, and a vertex coordinate list 2005. The reference defect ID 2003, the vertex count 2004, and the vertex coordinate list 2005 are in the same row configuration as the defect ID 502, the vertex count 503, and the vertex coordinate list 504 shown in FIG. 5A. In FIG. 21 described below, the defect data in the defect data table 2001 is displayed by a solid line.

The defect data table 2051 includes a defect ID 2052 for identifying defect data of a difference portion, a reference defect ID 2053 for identifying defect data serving as a reference before being differentiated to be a common portion or a difference portion, a vertex count 2054, and a vertex coordinate list 2055. The reference defect ID 2053, the vertex count 2054, and the vertex coordinate list 2055 are in the same row configuration as the defect data table shown in FIG. 20A. In FIG. 21 described below, the defect data in the defect data table 2051 is displayed by a dotted line.

The defect data table 2071 includes a defect ID 2072 for identifying defect data of a difference portion, a reference defect ID 2073 for identifying defect data serving as a reference before being differentiated to be a common portion or a difference portion, a vertex count 2074, and a vertex coordinate list 2075. The reference defect ID 2073, the vertex count 2074, and the vertex coordinate list 2075 are in the same row configuration as the defect data table shown in FIG. 20B. In FIG. 21 described below, the defect data in the defect data table 2071 is displayed by a double line.

### Display of Result of Aging Determination Processing

FIG. 21 is a diagram showing an example of a display screen of an aging calculation result. The aging calculation result is displayed in the result display region 721 shown in FIG. 7. A result image 2100 is an image displaying a result of performing aging determination after performing positional correction on the second defect data in conformity to the first defect data. In the result image 2100, defects (cracks) are indicated by one of a solid line representing defect data of a common portion, a dotted line representing defect data of a “disappeared” difference portion, and a double line representing defect data of an “appeared” difference portion.

The defect data of common portions corresponds to Cam 001 to Cam 011 of the defect data table 2001 shown in FIG. 20A. The defect data of “disappeared” difference portions corresponds to Cax 009 and Cax 012 of the defect data table 2051 shown in FIG. 20B. The defect data of “disappeared” difference portions corresponds to Cbx 001C, Cbx 002C, and Cbx 006C of the defect data table 2071 shown in FIG. 20C. Here, a “disappeared” difference portion is aligned with the corresponding common portion. Of the “disappeared” difference portions, those extended from the same defect (crack) are displayed on an extension of the same defect.

As described thus far, according to the first embodiment, the first defect data corresponding to the first inspection image and the second defect data corresponding to the second inspection image are subjected to positional displacement correction, and thereafter the change determination processing of the defect data is executed. In particular, the positional displacement correction is performed in two stages, namely, global positional displacement correction and local positional displacement correction. This enables more appropriate positional displacement correction, thus making it possible to accurately derive common portions and difference portions of the first defect data and the second defect data.

Since the difference portions of the defect data can be accurately derived, the user can easily grasp the relationship between the difference portions of the defect data and the common portions of the defect data when the common portions and the difference portions are displayed. For example, by displaying a difference portion that is present only in the second defect data in alignment with the first defect data, the user can intuitively grasp whether the difference portion is extended from a common portion, or is a separate defect (e.g., a new branch).

When an inspection image is a combination of a plurality of captured images, executing local positional displacement correction processing can appropriately correct positional displacement of defect data caused by boundaries and distortions of the captured images present in the inspection image. Furthermore, even in the case where some positional displacement remains, or there are shape differences between defects, executing expansion processing on defect data makes it possible to accurately determine the defect data to be the same defect data.

### Variations

### Global/Local Positional Displacement Correction Processing

In the first embodiment described above, an example is described in which the positional displacement amount is calculated by generating templates from the first inspection image, and executing matching processing on the second inspection image. Note, however, that the positional displacement amount may be calculated by generating templates from the second inspection image, and executing matching processing on the first inspection image. Also, the positional displacement amount may be calculated by integrating a result of searching for the second inspection image using the templates generated from the first inspection image, and a result of searching for the first inspection image using the templates generated from the second inspection image. This allows the positional displacement amount to be calculated from the two directions, thus increasing the accuracy of the displacement amount. In both cases, as for the direction of displacement, displacement of inspection data (inspection image and defect data) serving as a reference from inspection data serving as a correction target is calculated.

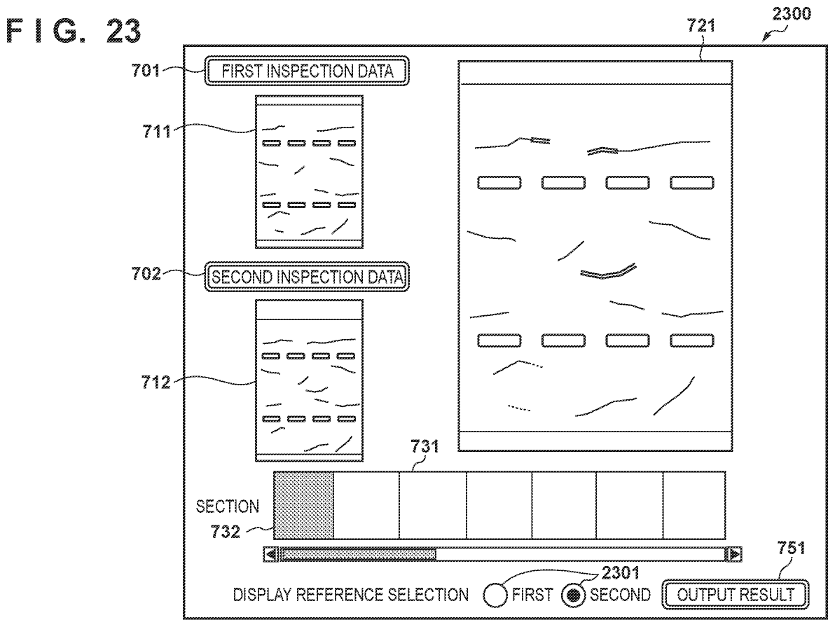

In the global positional displacement detection (S1002 and S1003) in the first embodiment, an example is described in which rectangular images obtained by dividing an inspection image into strips in the horizontal direction are used as templates. However, other forms of templates may be used. FIG. 22 is a diagram showing an example of another template used in the global positional displacement calculation processing. FIG. 22 shows an example in which a rectangular image 2202 circumscribing defect data 2201 is used as a template. This can increase the accuracy when an inspection image has few image features (a light, an emergency exit, a sign, etc.) and many defects.

Line segments having a length greater than or equal to a predetermined length and extending in a substantially horizontal direction may be detected from inspection images using edge detection or the like, then the line segments detected from the respective inspection images may be associated with each other according to their degrees of similarity, and the distance between the associated line segments in the vertical direction may be determined as a displacement amount. Here, the line segment extending in a substantially horizontal direction may be a line segment whose circumscribing rectangle has a height in the vertical direction that is less than or equal to a predetermined value, or a line segment having an angle to a horizontal line that is less than or equal to a predetermined value. The degrees of similarity of line segments are calculated from the differences in width in the horizontal direction between their circumscribing rectangles, and the angle formed therebetween, and a pair of line segments with the highest degree of similarity are associated with each other. This enables calculation to be performed with a lighter work load than template matching processing.

The displacement amount may be calculated using, in place of straight lines detected using edge detection, a diagonal line of a circumscribing rectangle of defect data or a center line in the horizontal direction. Also, both the diagonal line and the center line may be used in combination. Thus, by using information in which defect data is present, it is possible to calculate the displacement amount even when there are few image features in the horizontal direction.

Although the displacement amount is calculated for each section (span) in S1005, the displacement amount may be calculated using the degree of similarity between sections. For example, by collectively using all of the displacement amounts of all of the templates of all of the sections, the displacement amount can be calculated for a section on which template matching often fails. Furthermore, by determining the displacement amount of templates within a fixed number of adjacent sections by obtaining a moving average, it is also possible to calculate a correct displacement amount when an image-capturing vehicle changes the traveling position inside a long tunnel. Also, when sections with different image heights (corresponding to changes in the cross sectional shape of the tunnel) are present, the sections may be grouped accordingly, and the displacement amount may be calculated for each group. Thus, shape changes due to the presence of an escape region in the tunnel or switching of construction methods can also be dealt with. Note that differences in shape may be obtained from a design drawing of a structure that is prepared in advance, or may be determined from the heights of inspection images.

### Structure to be Inspected

In the first embodiment described above, an example is described in which a lining surface of a tunnel is an object to be inspected. However, a structure such as a floor plate of a bridge can also be an object to be inspected. When a floor plate of a bridge is an object to be inspected, an inspection image is often generated using an area between two beams as one unit of inspection. A plurality of captured images are combined to generate an inspection image in that case, since a high-resolution image is required to calculate defect data. In that case, as in the case of images of a tunnel, regions that are not to be inspected are recorded in a direction different from the direction in which images are connected. Accordingly, differences may occur in the sizes of the individual images, resulting in displacement in the positions of defects.

Although a pattern in which a surface to be inspected is continuous in the horizontal direction is described, the present disclosure can also be applied to a structure (or drawing) in which a surface to be inspected is continuous in the vertical direction. In that case, the search direction for calculating a global positional displacement amount may be set to the horizontal direction only.

### Forms of Display of State Change

In the first embodiment described above, an example is described in which positional displacement correction is performed on the second inspection data using the first inspection data as a reference for display, and aging determination processing is executed. This is suitable when state change data is superimposed on the first inspection image, which is an inspection result in the past, and defect data that has newly appeared at the second time point is confirmed. On the other hand, when defect data that is present only in the first inspection data (defect data that has disappeared) is to be confirmed, the inverse configuration may be employed. That is, positional displacement correction may be performed on the first inspection data using the second inspection data as a reference for display, and state change data may be displayed so as to be superimposed on the second inspection image. The display may be configured to be switched between two different forms of display, namely, display using the first inspection data as a reference (first embodiment) and display using the second inspection data as a reference. The positional displacement correction may be performed using the first inspection data as a reference, and only the form of display may be configured to be switched to display using the second inspection data as a reference.

FIG. 23 is a diagram showing an example of a GUI screen 2300 according to a variation. In the GUI screen 2300, display reference selection 2301, which is a UI component for switching between two different forms of display, is added to the GUI screen 700 of the first embodiment. For example, “First”, in which display using the first inspection data as a reference is performed, is selected upon starting a program, and the user selects “Second” by operating the input device 105 such as a mouse, as needed. When “Second” is selected, the display of the result display region 721 is updated.

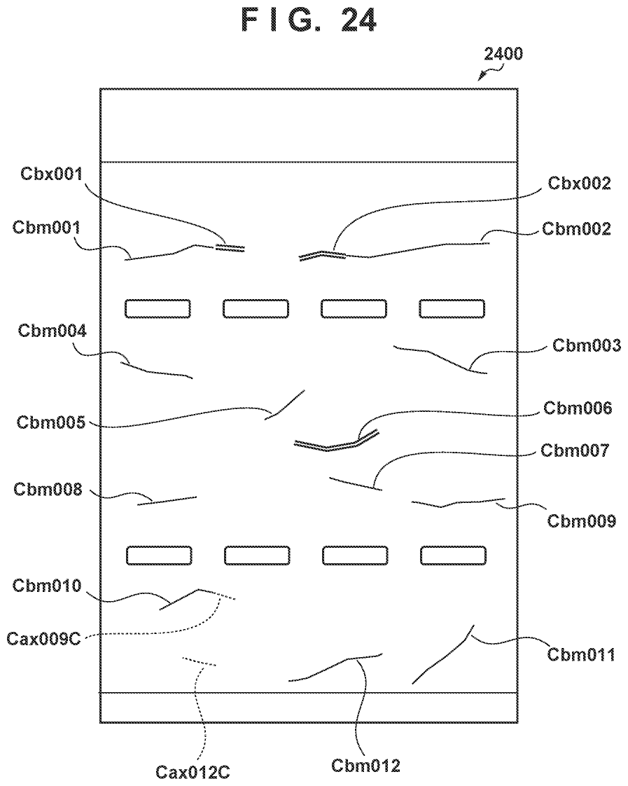

FIG. 24 is a diagram showing an example of a display screen of an aging calculation result according to a variation. Specifically, the drawing shows an aging result 2400 when “Second” is selected in the display reference selection 2301. Note that when “First” is selected, display similar to that shown in the aging result 2100 in FIG. 21 is provided.

In FIG. 24, defect data starting with Cbm (Cbm 001, etc.), which is indicated by a solid line, is defect data determined to be a common portion to the second defect data and the first defect data for which positional correction has been performed. Defect data starting with Cbx (Cbx 012, etc.), which is indicated by a double line, is defect data of a difference portion that is absent in an expansion region of the first defect data for which positional correction has been made, and present only in the second defect data. Defect data starting with Cax and ending with C (Cax 009C, etc.), which is indicated by a dotted line, shows defect data that is present only in the first defect data for which positional correction has been performed.

By enabling the display reference to be switchable, the user can confirm aging data using, as a reference, the inspection data at a time point that the user wishes to confirm. Also, in addition to using the position coordinates of defect data as a reference, the position coordinates of an inspection image may be used as a reference and be displayed in a superimposed manner. By providing display after performing positional correction not only on defect data that is present in an object (or at a time point) to be displayed, but also on defect data that is present only in the other defect data, it is possible to confirm a defect that is not shown in the inspection image used as a reference.

### OTHER EMBODIMENTS

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-123758, which was filed on Jul. 28, 2023 and which is hereby incorporated by reference herein in its entirety.

What is claimed is:

1. An information processing apparatus comprising:
one or more memories storing instructions; and
one or more processors that are in communication with the one or more memories and that, when executing the instructions, cooperate with the one or more memories to:
obtain first defect data generated based on a first captured image obtained by capturing an image of a target object at a first time point, the first defect data indicating a defect in the target object;
obtain second defect data generated based on a second captured image obtained by capturing an image of the target object at a second time point different from the first time point, the second defect data indicating a defect in the target object;
correct position coordinates of the second defect data using a first correction method in order to align a position in the first defect data with a position in the second defect data;
further correct, using a second correction method different from the first correction method, the position coordinates of the second defect data that have been corrected using the first correction method; and
determine, based on comparison between the first defect data and the second defect data corrected using the second correction method, a common portion that is a defect portion common to the two pieces of defect data, and a difference portion that is a defect portion different between the two pieces of defect data.

2. The information processing apparatus according to claim 1,
wherein the first correction method is one-dimensional correction based on one-dimensional positional displacement detection for a first range of the target object, and
the second correction method is two-dimensional correction based on two-dimensional positional displacement detection for a second range narrower than the first range.

3. The information processing apparatus according to claim 2,
wherein, with the first correction method, the one-dimensional positional displacement detection is performed by creating a first template image based on the first captured image, and performing template matching on the second captured image using the first template image, and,
with the second correction method, the two-dimensional positional displacement detection is performed by creating, based on the first captured image, a second template image having a smaller size than the first template image, and performing template matching on the second captured image using the second template image.

4. The information processing apparatus according to claim 2,
wherein the first captured image is one of a plurality of captured images obtained by capturing images of the target object while moving in a first direction, and
the one-dimensional positional displacement detection is performed for a second direction orthogonal to the first direction.

5. The information processing apparatus according to claim 1, further comprising:
storage configured to store defect change data representing the common portion and the difference portion.

6. The information processing apparatus according to claim 1, wherein, when executing the instructions, the one or more processors further cooperate with the one or more memories to:
display, in a display device, the common portion and the difference portion in alignment with each other,
wherein the common portion and the difference portion are displayed so as to be distinguishable from each other.

7. The information processing apparatus according to claim 6, wherein, when executing the instructions, the one or more processors further cooperate with the one or more memories to:
display, for the difference portion, a first difference portion that is present in the first defect data and absent in the second defect data, and a second difference portion that is absent in the first defect data and present in the second defect data so as to be distinguishable from each other.

8. The information processing apparatus according to claim 6, wherein, when executing the instructions, the one or more processors further cooperate with the one or more memories to:
display the common portion and the difference portion for the first captured image so as to be superimposed on each other, using position coordinates of the first defect data as a reference.

9. The information processing apparatus according to claim 6, wherein, when executing the instructions, the one or more processors further cooperate with the one or more memories to:
switch between first display to display the common portion and the difference portion for the first captured image so as to be superimposed on each other, using position coordinates of the first defect data as a reference; and second display to display the common portion and the difference portion for the second captured image so as to be superimposed on each other, using position coordinates of the second defect data as a reference.

10. A control method of an information processing apparatus, the method comprising:
obtaining first defect data generated based on a first captured image obtained by capturing an image of a target object at a first time point, the first defect data indicating a defect in the target object;
obtaining second defect data generated based on a second captured image obtained by capturing an image of the target object at a second time point different from the first time point, the second defect data indicating a defect in the target object;
correcting position coordinates of the second defect data using a first correction method in order to align a position in the first defect data with a position in the second defect data;
further correcting, using a second correction method different from the first correction method, the position coordinates of the second defect data that have been corrected using the first correction method; and
determining, based on comparison between the first defect data and the second defect data corrected using the second correction method, a common portion that is a defect portion common to the two pieces of defect data, and a difference portion that is a defect portion different between the two pieces of defect data.

11. A non-transitory computer-readable recording medium storing computer-executable instructions that, when executed by a computer, cause the computer to perform a control method of an information processing apparatus, the control method comprising:
obtaining first defect data generated based on a first captured image obtained by capturing an image of a target object at a first time point, the first defect data indicating a defect in the target object;
obtaining second defect data generated based on a second captured image obtained by capturing an image of the target object at a second time point different from the first time point, the second defect data indicating a defect in the target object;
correcting position coordinates of the second defect data using a first correction method in order to align a position in the first defect data with a position in the second defect data;
further correcting, using a second correction method different from the first correction method, the position coordinates of the second defect data that have been corrected using the first correction method; and
determining, based on comparison between the first defect data and the second defect data corrected using the second correction method, a common portion that is a defect portion common to the two pieces of defect data, and a difference portion that is a defect portion different between the two pieces of defect data.
